(19) United States
(12) Patent Application Publication
(10) Pub. No.: US 2009/0256958 A1
(43) Pub. Date: Oct. 15, 2009

(54) APPARATUS FOR DYNAMICALLY DETECTING INTERLACED IMAGE AND METHOD THEREOF

(76) Inventor: Po-Wei Chao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/101,159

(22) Filed: Apr. 11, 2008

(51) Int. Cl. H04N 11/22

(52) U.S. Cl. 348/452; 348/E11.022

(57) ABSTRACT

An apparatus for detecting an interlaced image includes a motion detector, a mixed mode detector, a film mode detector, a buffering unit and a mixed range detector. When a film including a plurality of fields is input to the apparatus, motion values of an input field are first detected, and film mode information of the input field is detected according to the motion values. The mixed mode detector detects the interlaced image in the input field according to the motion values to generate a detection result, and selectively stores the detection result into the buffering unit according to the film mode information. The moving direction of the interlaced images in the film can be determined according to the detection result stored in the buffering unit, and the mixed range detector dynamically determines information of the interlaced images in the following input fields.

### BACKGROUND

The present invention relates to an image processing technique, and more particularly, to an apparatus for dynamically detecting an image interlaced in a field, and a method thereof.

Image interlaced in a film (referred to as “interlaced image” herein), such as a news ticker or staff list scrolling across the screen at the end of a movie, must be distinguished from the film before decoding because the processing method for the interlaced image and the processing method for the film directly are different. One of the common techniques to process the interlaced image is interpolation.

FIG. 1 is a block diagram of a conventional interlaced-image detection device 100. The video input into the interlaced-image detection device 100 is a film including an interlaced image as shown in FIG. 2, and the interlaced-image detection device 100 detects the area of the interlaced image. As shown in FIG. 1, the conventional interlaced-image detection device 100 comprises a motion detector 110, a mixed mode detector 120 and a film mode detector 130. The motion detector 110, for detecting motion values of an input film, can be a frame motion detector or a field motion detector. The film mode detector 130 determines the film mode according to the motion values output from the motion detector 110, and then the interlaced image is detected in the mixed mode detector 120 according to information provided by the motion detector 110 and the film mode detector 130, i.e. motion values and film mode of the input film. Since the motion detector 110, the mixed mode detector 120 and the film mode detector 130 are well known in the art, further description is omitted for brevity.

After the interlaced image is distinguished and identified from the input film, it is processed separately; for example, the interpolation method is performed on the interlaced image simultaneously while a film process is performed on the other part of the input film. If an area of the interlaced image is incorrectly determined so that the interlaced image is processed by the film process and the input film is processed by the interpolation process, a sawtooth-effect or noise will occur in the decoding result thereby the picture quality is degraded with a great amount. Decoding performance of the input film is therefore highly related to the determining accuracy of where the interlaced image is located. The conventional interlaced-image detection device 100, however, can only detect interlaced images on a fixed location because the detection mechanism mentioned above is fixed. That is, if the location or area of the interlaced image changes over time (such as a news sticker running from the bottom right corner to the bottom left corner of a TV screen), the conventional interlaced-image detection device 100 is not able to detect this interlaced image correctly.

### SUMMARY

One objective of the present invention is therefore to provide an apparatus for dynamically detecting interlaced images in a film, and a method thereof, to overcome the above problems. The apparatus of the present invention can trace the moving direction of the interlaced image, and dynamically adjust the detection mechanism utilized to determine the area of the interlaced image according to the moving direction. Simple and efficient interlaced-image detection is therefore achieved.

According to an exemplary embodiment of the present invention, an apparatus for detecting an interlaced image is disclosed. The apparatus includes an interlaced image detection module and a buffering unit coupled to the interlaced image detection module. In the interlaced image detection module, a motion detector first detects motion values of an input field, and a film mode detector then detects film mode information of the input field according to the motion values. A mixed mode detector of the interlaced image detection module detects the interlaced image of the input field according to the motion values to generate a detection result, and selectively stores the detection result into the buffering unit according to the film mode information. Information of an interlaced image in a following input field is determined according to the detection result stored in the buffering unit and the film mode information.

According to another exemplary embodiment of the present invention, a method of detecting an interlaced image is disclosed. The method includes detecting motion values of a first input field, detecting a film mode information of the first input field according to the motion values, detecting the interlaced image of the first input field according to the motion values to generate a detection result, and selectively buffering the detection result according to the film mode information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a conventional interlaced-image detecting device.

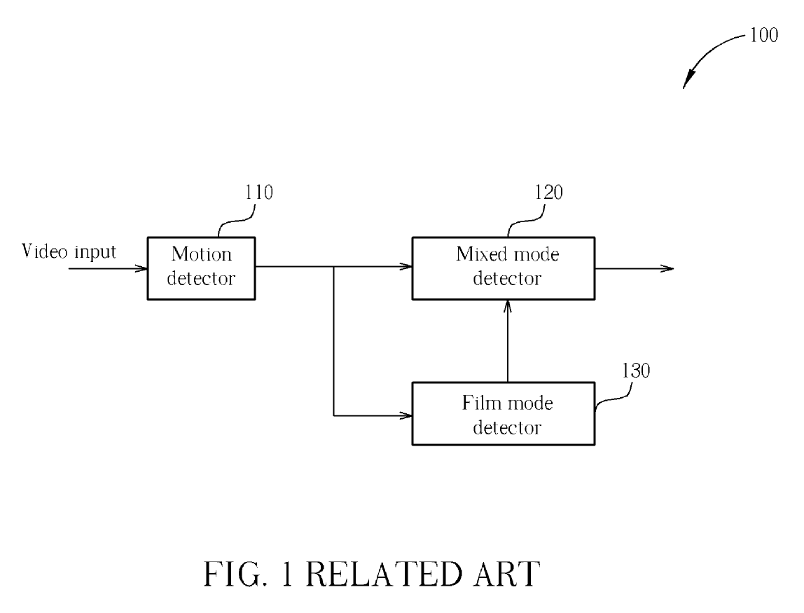

FIG. 2 is a diagram showing an image interlaced in a film.

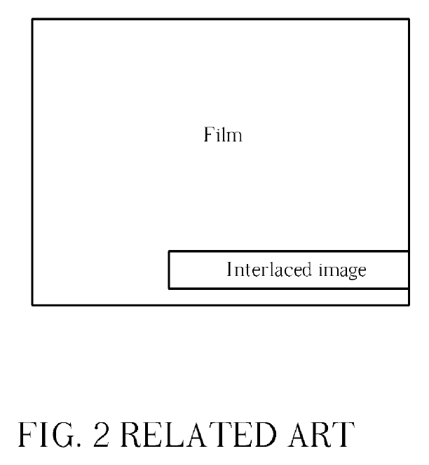

FIG. 3 is a block diagram of an apparatus for dynamically detecting an interlaced image according to an exemplary embodiment of the present invention.

FIG. 4 shows an example of a 3:2 pull-down video data sequence processed by frame motion detection.

FIG. 5 shows an example of a 3:2 pull-down video data sequence processed by field motion detection.

FIG. 6 is a block diagram of an apparatus for dynamically detecting an interlaced image according to another exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

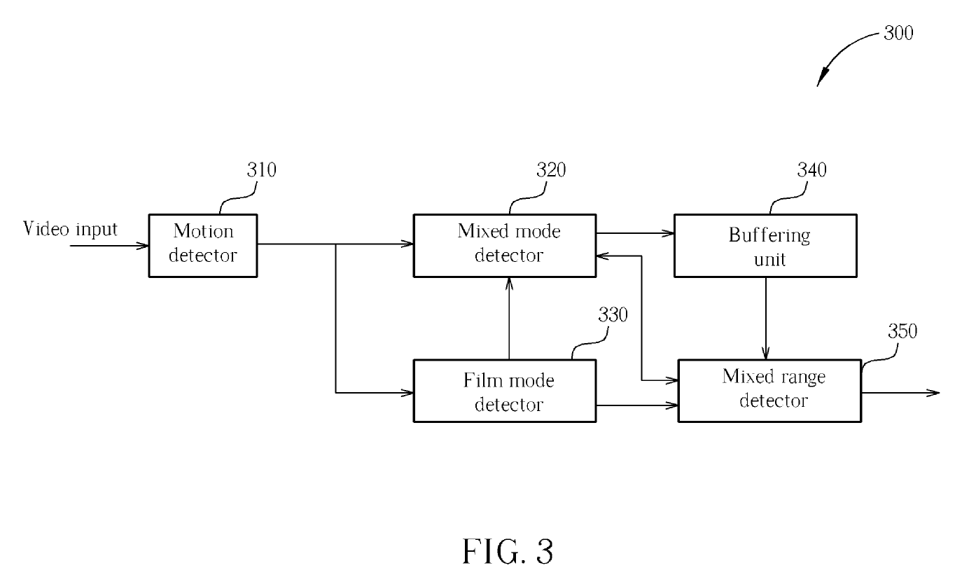

Please refer to FIG. 3, which is a diagram of an apparatus 300 for detecting an interlaced image according to an exemplary embodiment of the present invention. The apparatus 300 includes a motion detector 310, a mixed mode detector 320, a film mode detector 330, a buffering unit 340, and a mixed range detector 350. When a field is input into the apparatus 300, the motion detector 310 first detects motion values of the input field. The mixed mode detector 320 then detects whether the input field includes an interlaced image according to the motion values, and detects information of the interlaced image (for example, the start and end coordinates of the interlaced image in the input field).

Meanwhile, the motion values detected by the motion detector 310 are also delivered to the film mode detector 330 for detecting film mode information of the input field. The detected film mode information, such as a 3:2 pull-down mode or a 2:2 pull-down mode, is delivered to the mixed mode detector 320, which selectively stores detected information of the interlaced image into the buffering unit 340 according to the film mode information. Based on the detected information stored in the buffering unit 340 and the film mode information, the mixed range detector 350 can dynamically determine information of an interlaced image in another input field that the mixed mode detector 320 may be unable to detect.

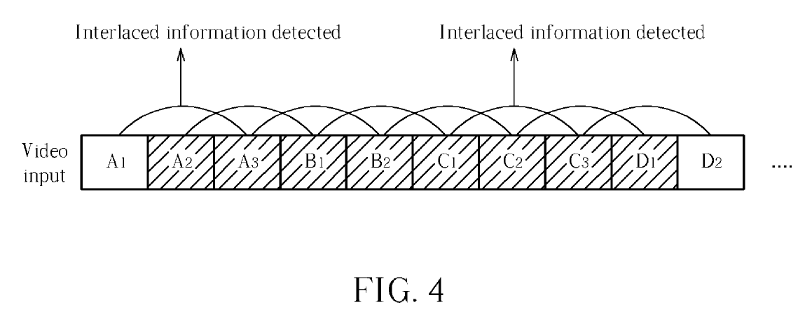

In order to specifically explain the above operations, an example of a 3:2 pull-down video data sequence is shown in FIG. 4. In FIG. 4, each field is labeled with a letter plus a number. Fields having the same letter (such as A₁, A₂ and A₃) are generated from the same film frame and each of the fields is assigned a corresponding number. Moreover, fields having interlaced images therein (such as A₂-D₁) are shown with oblique lines. Note that the interlaced image moves in the film over time in this embodiment, meaning that positions of the interlaced images are not fixed.

The motion detector 310 is a frame motion detector in this embodiment. Therefore, the interlaced image in field A₃ can be detected by the motion detector 310 when field A₁ is compared to field A₃, but the interlaced image in field A₂ cannot be detected by the motion detector 310 when field A₂ is compared to field B₁. This is because the fields A₁ and A₃ belong to the same film frame, and the motion values detected by comparing the field A₁ with the field A₃ must correspond to the interlaced image in the field A₃. The fields A₂ and B₁, however, belong to different film frames, and the motion values detected by comparing the field A₂ with the field B₁ are composed of motion values resulting from the different film frame and motion values resulting from the interlaced images. It is hard to obtain information of interlaced image from the motion values of fields A₂ and B₁. Therefore, only when the film mode information indicates that input fields processed by the motion detector 310 correspond to an identical field of a film frame (for example, fields A₁ and A₃, and fields C₁ and C₃) will the detection results of the mixed mode detector 320 be stored into the buffering unit 340.

Based on the information stored in the buffering unit 340 and the film mode information provided by the film mode detector 330, the mixed range detector 350 determines moving directions and positions of the interlaced images. In one embodiment, the mixed range detector 350 detects sequence information of the input fields (for example, field A₃ is the third field in the input sequence, field C₃ is the eighth field in the input sequence) according to the film mode information, then equally divides the position difference of the interlaced images in fields A₃ and C₃ by five (since there are five fields between the fields A₃ and C₃) to predict the locations of the interlaced images in fields B₁-C₂. This tendency can also be applied to predict the locations of the interlaced images in following fields (fields D₁ and D₂, etc.). In another embodiment, the mixed range detector 350 simply sets the locations of the interlaced images in fields B₁-C₂ by the detected location of the interlaced image in field A₃. In this way, the calculation complexity is reduced while the detection accuracy of the apparatus 300 is slightly sacrificed.

The mixed range detector 350 can further transmit the information of the interlaced image to the mixed mode detector 320 to help the mixed mode detector 320 detect the interlaced image in following input fields. The tracing of the moving interlaced image is accomplished in the mixed mode detector 320, and the output of the mixed mode detector 320 is an adjusted information of the interlaced image in each field.

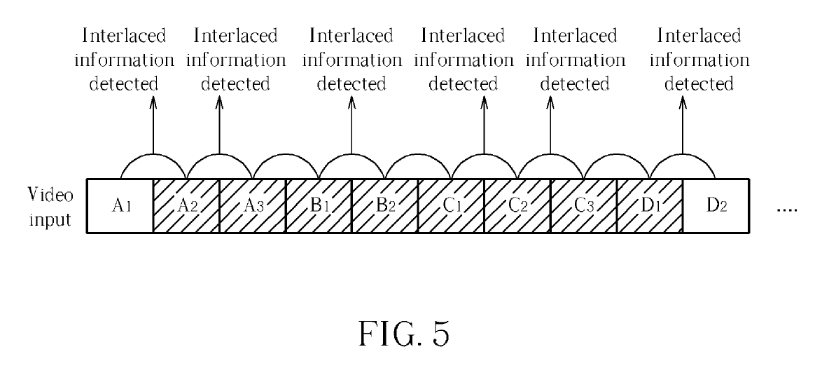

Please note that the frame motion detection method is only one example of the present invention. In another embodiment, field motion detection is implemented in the motion detector 310. Please refer to FIG. 5. When the 3:2 pull-down video data sequence shown in FIG. 4 is processed by the field motion detector, the mixed mode detector 320 stores the detection results generated from two input fields corresponding to an identical film frame into the buffering unit 340, and neglects other detection results (i.e. they are not stored into the buffering unit 340). Similarly, the mixed range detector 350 can determine moving directions and positions of the interlaced images by setting them to be equal to the position information stored in the buffering unit 340 or by averaging the position information stored in the buffering unit 340.

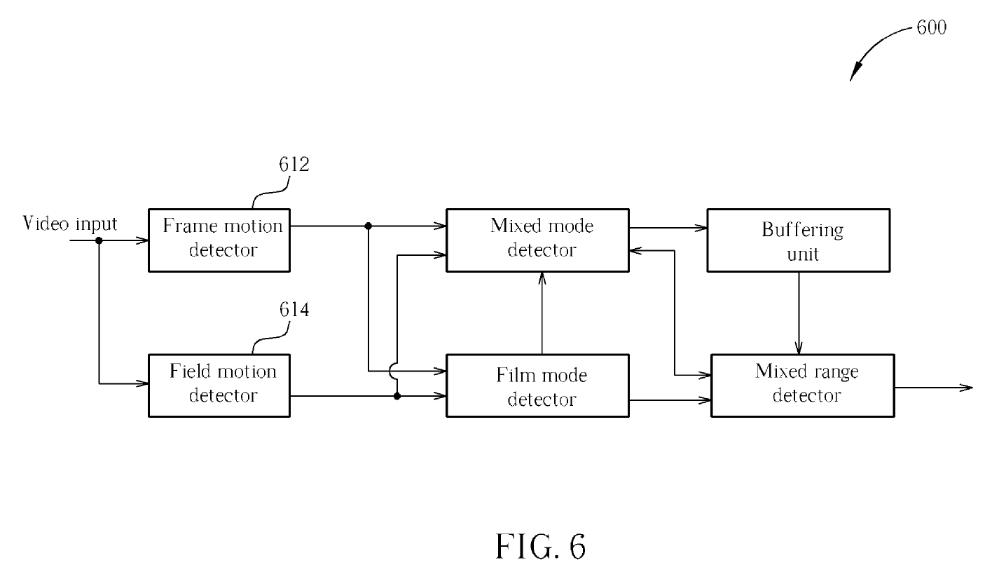

Moreover, the accuracy of interlaced image detection can be further improved by adopting both frame motion detection and field motion detection. FIG. 6 is a block diagram of an apparatus 600 for dynamically detecting an interlaced image according to another exemplary embodiment of the present invention. As shown in FIG. 6, the detection results of a frame motion detector 612 and a field motion detector 614 are both utilized for interlaced image detection. In other words, the detection mechanisms corresponding to FIG. 4 and FIG. 5 are implemented together to derive more accurate information of interlaced images.

The 3:2 pull-down mode is only an example and not a limitation of the present invention. The apparatus 300 or 600 can also be implemented to dynamically detect an interlaced image in a 2:2 pull-down film. Since a person skilled in the art can easily appreciate this modification, further description is omitted here for brevity.

By using the detection mechanism disclosed above, a moving interlaced image can be detected more accurately than in the prior art. Therefore, a better decoding performance of the film is obtained with the added advantages of simplicity and low cost.

Those skilled in the art will readily observe that numerous modifications and alterations of the device and method may be made while retaining the teachings of the invention.

What is claimed is:

1. An apparatus for detecting an interlaced image, comprising:
an interlaced image detection module, comprising:
a motion detector, for detecting motion values of a first input field;
a mixed mode detector, coupled to the motion detector, for detecting an interlaced image of the first input field according to the motion values to generate a detection result; and
a film mode detector, coupled to the motion detector and the mixed mode detector, for detecting a film mode information of the first input field according to the motion values; and
a buffering unit, coupled to the interlaced image detection module, wherein the mixed mode detector selectively stores the detection result into the buffering unit according to the film mode information.

2. The apparatus of claim 1, wherein the motion detector comprises a frame motion detector.

3. The apparatus of claim 2, wherein the mixed mode detector stores the detection result into the buffering unit when the film mode information indicates that the first input field and a second input field processed by the frame motion detector correspond to an identical field of an image frame.

4. The apparatus of claim 1, wherein the motion detector comprises a field motion detector.

5. The apparatus of claim 4, wherein the mixed mode detector stores the detection result into the buffering unit when the film mode information indicates that the first input field and a second input field processed by the field motion detector correspond to an identical image frame.

6. The apparatus of claim 1, further comprising:
a mixed range detector, coupled to the interlaced image detection module and the buffering unit, for determining information of an interlaced image of a second input field according to the detection result stored in the buffering unit and the film mode information.

7. The apparatus of claim 6, wherein the mixed range detector further detects a moving direction of the interlaced image of the first input field, and determines the information of the interlaced image of the second input field according to the detection result stored in the buffering unit, the moving direction of the interlaced image of the first input field, and sequence information of the first input field and the second input field determined by the film mode detector.

8. The apparatus of claim 6, wherein the mixed range detector further transmits the information of the interlaced image of the first input field to the mixed mode detector, and the mixed mode detector detects the interlaced image of the second input field according to motion values of the second input field detected by the motion detector and the information of the interlaced image of the first input field.

9. The apparatus of claim 6, wherein the mixed range detector determines the information of the interlaced image of the second input field through setting the information of the interlaced image of the second input field by the detection result stored in the buffering unit.

10. A method of detecting an interlaced image, comprising:
detecting motion values of a first input field;
detecting a film mode information of the first input field according to the motion values;
detecting an interlaced image of the first input field according to the motion values to generate a detection result; and
selectively buffering the detection result according to the film mode information.

11. The method of claim 10, wherein the step of detecting the motion values of the input field comprises utilizing a frame motion detection mechanism to detect the motion values.

12. The method of claim 11, wherein the step of selectively buffering the detection result according to the film mode information comprises buffering the detection result when the film mode information indicates that the first input field and a second input field processed by the frame motion detection mechanism correspond to an identical field of an image frame.

13. The method of claim 10, wherein the step of detecting the motion values of the input field comprises utilizing a field motion detection mechanism to detect the motion values.

14. The method of claim 13, wherein the step of selectively buffering the detection result according to the film mode information comprises buffering the detection result when the film mode information indicates that the first input field and a second input field processed by the field motion detection mechanism correspond to an identical image frame.

15. The method of claim 10, further comprising:
determining information of an interlaced image of a second input field according to the buffered detection result and the film mode information.

16. The method of claim 15, further comprising detecting a moving direction of the interlaced image of the first input field, and the step of determining information of the interlaced image of the second input field comprises determining the information of the interlaced image of the second input field according to the buffered detection result, the moving direction of the interlaced image of the first input field, and sequence information of the first input field and the second input field determined by the film mode detector.

17. The method of claim 15, wherein the step of detecting the interlaced image of the second input field comprises detecting the interlaced image of the second input field according to motion values of the second input field and the information of the interlaced image of the first input field.

18. The method of claim 15, wherein the step of determining the information of the interlaced image of the second input field comprises setting the information of the interlaced image of the second input field by the buffered detection result.
